(19) United States
(12) Patent Application Publication
(10) Pub. No.: US 2022/0327405 A1
(43) Pub. Date: Oct. 13, 2022

(54) Inference Processing Apparatus and Inference Processing Method

(71) Applicant: Nippon Telegraph and Telephone Corporation, Tokyo (JP)

(72) Inventors: Huycu Ngo, Tokyo (JP); Yuki Arikawa, Tokyo (JP); Takeshi Sakamoto, Tokyo (JP)

(21) Appl. No.: 17/615,945

(22) PCT Filed: Jun. 5, 2019
(86) PCT No.: PCT/JP2019/022314

§ 371 Date: Dec. 2, 2021

(51) Int. Cl. G06N 5/04

(52) U.S. Cl. CPC G06N 5/04

(57) ABSTRACT

The inference processing apparatus includes an inference calculator that performs calculation of a neural network based on input data xₜ of each consecutive time step and weights W of a trained neural network to infer features of the input data xₜ and also includes a memory that stores input data xₜ and weight W, a temporary memory that stores an output hₜ₋₁ of an inference result of an immediately previous time step, and a switching controller that controls switching between a first operation mode T_{M1} in which the inference calculator performs calculation of the neural network based on the input data xₜ, the weight W, and the output hₜ₋₁, at each time step and a second operation mode T_{M2} in which the inference calculator performs calculation of the neural network based on the input data xₜ and the weight W at each time step.

### CROSS-REFERENCE TO RELATED APPLICATIONS

This application is a national phase entry of PCT Application No. PCT/JP2019/022314, filed on Jun. 5, 2019, which application is hereby incorporated herein by reference.

### TECHNICAL FIELD

The present invention relates to an inference processing apparatus and an inference processing method, and more particularly to a technique for performing inference using a recurrent neural network.

### BACKGROUND

In recent years, the amount of data generated has increased explosively with an increasing number of edge devices such as mobile terminals and Internet of Things (IoT) devices. A state-of-the-art machine learning technology called a deep neural network (DNN) is superior in extracting meaningful information from such an enormous amount of data. Due to recent advances in research on DNNs, the accuracy of data analysis has been significantly improved and further development of technology using DNNs is expected.

The processing of a DNN has two phases, training and inference. In general, training requires a large amount of data and is sometimes processed in a cloud. On the other hand, inference uses a trained DNN model to estimate an output for unknown input data.

More specifically, in DNN-based inference processing, input data such as time series data or image data is given to a trained neural network model to infer features of the input data. For example, according to a specific example disclosed in Non Patent Literature 1, a sensor terminal equipped with an acceleration sensor and a gyro sensor is used to detect events such as rotation or stopping of a garbage truck to estimate the amount of waste. In this way, a pre-trained neural network model trained using time series data in which events at times are known is used to estimate an event at each time by taking unknown time series data as an input.

In Non Patent Literature 1, it is necessary to extract events in real time using time series data acquired from the sensor terminal as input data. Therefore, it is necessary to speed up the inference processing. Thus, in a technique of the related art, an FPGA that implements inference processing is mounted on a sensor terminal and inference calculation is performed with the FPGA to speed up the processing (see Non Patent Literature 2).

A recurrent neural network (RNN) has been used for inference on time series data and natural language. The RNN model has a network structure in which so-called feedback is performed such that a value of an intermediate layer is input to the intermediate layer again. A long short term memory (LSTM) is known as a typical RNN model (see Non Patent Literature 2). The LSTM is an NN model capable of learning from long-term time series data and may be incorporated into a DNN as a part thereof.

The LSTM has an input layer, an intermediate layer, and an output layer, similar to the RNN, but has a structure with each unit of the intermediate layer of the RNN replaced with an LSTM block including an element called a memory cell. This LSTM block controls an input gate, a forget gate, and an output gate and determines a current output for an input, for example, by using an output of an immediately previous time step. The input gate selects whether to acquire the input, the forget gate selects how much to retain the state of the memory cell of the time of the immediately previous step at the current time step, and the output gate selects how much information to pass to the next time step as an output.

In the inference processing technique using an LSTM disclosed in Non Patent Literature 2, two feedback loops of feedback of the output and feedback of the memory cell state are provided.

### CITATION LIST

### Non Patent Literature

Non Patent Literature 1: Kishino, et. al, “Detecting Garbage Collection Duration Using Motion Sensors Mounted on a Garbage Truck Toward Smart Waste Management,” SPWID17

Non Patent Literature 2: Kishino, et. al, “Datafying city: Detecting and Accumulating Spatio-temporal Events by Vehicle-mounted Sensors,” BIGDATA 2017.

### SUMMARY

### Technical Problem

However, in the technique described in Non Patent Literature 2, input data needs to be calculated serially and pipeline processing and parallel processing cannot be applied because two feedbacks, output feedback and feedback of the memory cell state of the LSTM, are always performed. Thus, it is difficult to reduce the processing time of inference calculation.

Embodiments of the present invention have been made to solve the above problems and it is an object of embodiments of the present invention to provide an inference processing technique capable of reducing the processing time of inference calculation.

### Means for Solving the Problem

An inference processing apparatus according to embodiments of the present invention to solve the above problems is an inference processing apparatus including an inference calculation unit configured to perform calculation of a neural network based on input data of each of consecutive time steps and a weight of a trained neural network to infer a feature of the input data, the inference processing apparatus further including a first storage unit configured to store the input data, a second storage unit configured to store the weight, a third storage unit configured to store a first value relating to an inference result of the neural network, and a first switching control unit configured to perform control to switch between a first operation mode in which the inference calculation unit performs calculation of the neural network based on the input data, the weight, and the first value at each of the time steps and a second operation mode in which the inference calculation unit performs calculation of the neural network based on the input data and the weight at each of the time steps wherein the first value is an inference result obtained by the inference calculation unit at an immediately previous time step.

In the inference processing apparatus according to embodiments of the present invention, the first switching control unit may include a first determination unit configured to determine whether or not the first operation mode or the second operation mode has ended based on a preset condition regarding a number of pieces of input data to be processed by the inference calculation unit, and a first switching unit configured to generate a control signal indicating switching between the first operation mode and the second operation mode based on a determination result of the first determination unit.

The inference processing apparatus according to embodiments of the present invention may further include a memory control unit configured to read the input data corresponding to a preset batch size from the first storage unit when the control signal indicates switching to the second operation mode wherein the inference calculation unit is configured to batch-process calculations of the neural network based on the input data corresponding to the batch size and the weight in the second operation mode to infer a feature of the input data.

The inference processing apparatus according to embodiments of the present invention may further include a fourth storage unit configured to store a second value relating to an internal state of an intermediate layer of the neural network, and a second switching control unit configured to perform control to switch between a third operation mode in which the inference calculation unit performs calculation of the neural network using the second value at each of the time steps and a fourth operation mode in which the inference calculation unit performs calculation of the neural network without using the second value at each of the time steps wherein the second value is an internal state of the intermediate layer of the neural network at an immediately previous time step.

In the inference processing apparatus according to embodiments of the present invention, the second switching control unit may include a second determination unit configured to determine whether or not the third operation mode or the fourth operation mode has ended based on a preset condition regarding a number of pieces of input data to be processed by the inference calculation unit, and a second switching unit configured to generate a control signal indicating switching between the third operation mode and the fourth operation mode based on a determination result of the second determination unit.

In the inference processing apparatus according to embodiments of the present invention, the inference calculation unit may include a plurality of the inference calculation units to perform calculations of the neural network in parallel.

In the inference processing apparatus according to embodiments of the present invention, the neural network may be a recurrent neural network.

An inference processing method according to embodiments of the present invention to solve the above problems is an inference processing method for performing calculation of a neural network based on input data of each of consecutive time steps and a weight of a trained neural network to infer a feature of the input data, the inference processing method including performing control to switch between a first operation mode in which calculation of the neural network is performed based on the input data stored in a first storage unit, the weight stored in a second storage unit, and a first value relating to an inference result of the neural network stored in a third storage unit at each of the time steps and a second operation mode in which calculation of the neural network is performed based on the input data and the weight at each of the time steps wherein the first value is an inference result obtained through calculation of the neural network at an immediately previous time step.

### Effects of Embodiments of the Invention

According to embodiments of the present invention, the processing time of inference calculation can be reduced because control is performed to switch between the first operation mode in which the calculation of the neural network is performed based on the input data, the weight, and the first value relating to the inference result of the neural network at each time step and the second operation mode in which the calculation of the neural network is performed based on the input data and the weight at each time step.

### BRIEF DESCRIPTION OF THE DRAWINGS

FIG. 1 is a block diagram illustrating a configuration of an inference processing apparatus according to a first embodiment of the present invention.

FIG. 2 is a block diagram illustrating a configuration of a switching control unit according to the first embodiment.

FIG. 3 is a block diagram illustrating a configuration of an inference calculation unit according to the first embodiment.

FIG. 4 is a block diagram illustrating a configuration of a matrix calculation unit according to the first embodiment.

FIG. 5 is a block diagram illustrating a hardware configuration of the inference processing apparatus according to the first embodiment.

FIG. 6 is a diagram for explaining an operation of a switching control unit according to the first embodiment.

FIG. 7 is a flowchart illustrating an operation of the inference processing apparatus according to the first embodiment.

FIG. 8 is a flowchart illustrating switching control according to the first embodiment.

FIG. 9 is a diagram for explaining the advantages of the first embodiment.

FIG. 10 is a block diagram illustrating a configuration of an inference calculation unit according to a second embodiment.

FIG. 11 is a diagram for explaining the advantages of the second embodiment.

FIG. 12 is a block diagram illustrating a configuration of an inference processing apparatus according to a third embodiment.

FIG. 13 is a block diagram illustrating a configuration of a switching control unit according to the third embodiment.

FIG. 14 is a diagram for explaining an operation of the switching control unit according to the third embodiment.

FIG. 15 is a flowchart illustrating the operation of the switching control unit according to the third embodiment.

FIG. 16 is a flowchart illustrating the operation of the switching control unit according to the third embodiment.

FIG. 17 is a block diagram illustrating a configuration of an inference processing apparatus according to a fourth embodiment.

FIG. 18 is a block diagram illustrating a configuration of an inference processing apparatus according to an example of the current system.

### DETAILED DESCRIPTION OF ILLUSTRATIVE EMBODIMENTS

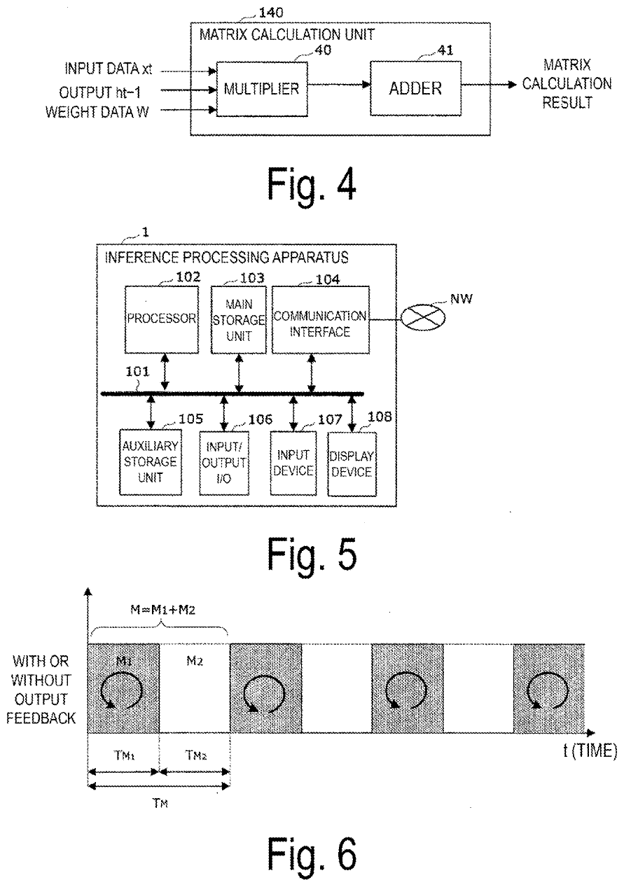

Hereinafter, preferred embodiments of the present invention will be described in detail with reference to FIGS. 1 to 18.

Outline of Embodiments of Invention

First, an outline of an inference processing apparatus 1 according to an embodiment of the present invention will be described. FIG. 1 is a block diagram illustrating a configuration of the inference processing apparatus 1 according to a first embodiment of the present invention. The inference processing apparatus 1 according to the present embodiment uses image data or time series data such as audio data and language data acquired from an external sensor or the like (not illustrated) as input data xₜ for inference. The inference processing apparatus 1 uses an RNN as a neural network model.

The inference processing apparatus 1 takes input data xₜ, weight data W, and an output hₜ₋₁ of an immediately previous time step which is a return value as inputs, performs a forward propagation calculation of the RNN to infer features of the input data xₜ, and outputs an inference result hₜ.

For example, the inference processing apparatus 1 uses input data xₜ such as time series data in which events at times are known and a trained RNN model that has been pre-trained. The inference processing apparatus 1 estimates an event at each time by using input data xₜ such as unknown time series data, weight data W of a trained RNN, and an output hₜ₋₁ which is a return value of the RNN as inputs.

For example, the inference processing apparatus 1 can estimate the amount of waste by detecting events such as rotation or stopping of a garbage truck using input data xₜ acquired from sensors including an acceleration sensor and a gyro sensor (see Non Patent Literature 1).

The inference processing apparatus 1 according to the present embodiment uses an LSTM which is a type of RNN. Hereinafter, a procedure of inference calculation of the LSTM will be described. The bias which is a parameter of the neural network (NN) model will be omitted for the sake of simplicity.

As described above, when input data xₜ is given, the LSTM performs an internal calculation using its own output hₜ₋₁ of an immediately previous time step (t−1) to determine an output hₜ at the current time step (t). The current output hₜ is also used to determine an output hₜ₊₁ at the next time step (t+1). The input data xₜ, the outputs hₜ and hₜ₋₁ of the LSTM block, states cₜ and cₜ₋₁ of the memory cell, and the weight data W are matrices.

At the input gate of the LSTM, weight data Wₓᵢ is prepared for the input data xₜ and weight data Wₕᵢ is prepared for the output hₜ₋₁, and a sigmoid function σ is applied to the result of a product-sum calculation of them to perform the calculation of the following equation (1).

iₜ=σ(Wₓᵢxₜ+Wₕᵢhₜ₋₁) (1)

At the forget gate, weight data W_{xf} is prepared for the input data xₜ and weight data W_{hf} is prepared for the output hₜ₋₁ to perform the calculation of the following equation (2).

fₜ=σ(W_{xf}xₜ+W_{hf}hₜ₋₁) (2)

At the output gate, weight data Wₓₒ is prepared for the input data xₜ and weight data Wₕₒ is prepared for the output hₜ₋₁ to perform the calculation of the following equation (3).

oₜ=σ(Wₓₒxₜ+Wₕₒhd t−1) (3)

Further, in the tanh layer, a vector gₜ of new candidate values added to the state of the memory cell is obtained through the following equation (4). Weight data W_{xc} is prepared for the input data xₜ and weight data W_{hc} is prepared for the output hₜ₋₁.

gₜ=tanh(W_{xc}xₜ+Wₕₑhₜ₋₁) (4)

Further, on the input gate side, the values of the above equations (1) and (3) are multiplied to calculate iₜ*gₜ. The calculation result fₜ of the forget gate is multiplied by the state cₜ₋₁ of the memory cell of the time of the immediately previous step output from the memory cell to calculate fₜ*cₜ₋₁. Here, * indicates element-wise multiplication.

Downstream of the memory cell, the above two values are added together and the state cₜ of the memory cell is obtained through the following equation (5).

cₜ=fₜ*cₜ₋₁+iₜ*gₜ (5)

A final output hₜ is calculated through the following equation (6) using the state cₜ of the memory cell (equation (5)) obtained from the memory cell and the value oₜ (equation (3)) obtained from the output gate.

hₜ=oₜ*tanh(cₜ) (6)

As shown in the above equations (1) to (6), the state cₜ₋₁ of the memory cell and the output hₜ₋₁ of the LSTM block of the immediately previous time step are fed back and used to calculate the output hₜ of the current time.

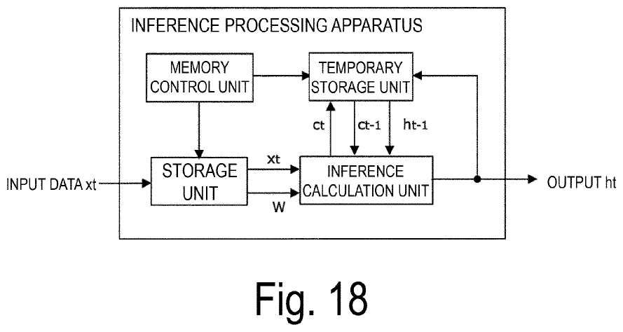

Here, in an inference processing apparatus according to an example of the current system illustrated in FIG. 18, feedback of the state of the memory cell and feedback of the output are always performed in the inference calculation through two feedback loops. Thus, the inference processing apparatus according to the example of the current system serially calculates data.

The inference processing apparatus 1 according to the present embodiment has a feature that control is performed to alternately switch between a first operation mode in which output feedback is performed and a second operation mode in which no output feedback is performed. Also, in the second operation mode in which no output feedback is performed, the inference processing apparatus 1 calculates a plurality of pieces of input data xₜ at the same time through batch processing.

### First Embodiment

Next, the configuration of the inference processing apparatus 1 according to the first embodiment will be described with reference to the block diagrams of FIGS. 1 to 4.

The inference processing apparatus 1 includes a storage unit (a first storage unit and a second storage unit) 10, a memory control unit 11, a temporary storage unit (a third storage unit and a fourth storage unit) 12, a switching control unit (a first switching control unit) 13, and an inference calculation unit 14.

The storage unit 10 stores input data xₜ of each consecutive time step such as time series data acquired from an external sensor or the like. The storage unit 10 also stores a trained RNN that has been pre-trained and constructed through a calculation device such as an external server, that is, weight data W in the above equations (1) to (6).

The memory control unit 11 reads input data xₜ and weight data W of the trained RNN from the storage unit 10 and transfers them to the inference calculation unit 14. The memory control unit ii also performs reading and writing of a state cₜ₋₁ and an output hₜ₋₁ of the memory cell of an immediately previous time step stored in the temporary storage unit 12 based on a control signal from the switching control unit 13.

Further, the memory control unit 11 reads pieces of input data xₜ to x_{t+Batch-1} corresponding to a preset batch size and weight data W corresponding to the pieces of input data xₜ to x_{t+Batch-1} from the storage unit 10 based on a control signal from the switching control unit 13 and transfers them to the inference calculation unit 14.

The temporary storage unit 12 temporarily stores the state cₜ₋₁ (a second value) and the output hₜ₋₁ (a first value) of the memory cell of the immediately previous time step. Whether or not the output hₜ₋₁ of the immediately previous time step is written to the temporary storage unit 12 is determined according to a control signal from the switching control unit 13 which will be described later.

The switching control unit 13 performs control to alternately switch between a first operation mode in which the output hₜ₋₁ of the immediately previous time step is used for inference calculation in the inference calculation unit 14 (hereinafter referred to as a “first operation mode T_{M1}”) and a second operation mode in which the output hₜ₋₁ of the immediately previous time step is not used for inference calculation in the inference calculation unit 14 (hereinafter referred to as a “second operation mode T_{M2}”). Hereinafter, giving the output hₜ₋₁ of the immediately previous time step as an input for inference calculation in the inference calculation unit 14 is referred to as “output feedback.”

By the switching control unit 13 performing control to alternately switch between the first operation mode T_{M1} and the second operation mode T_{M2}, output feedback is performed at some intervals in the inference calculation of the inference calculation unit 14.

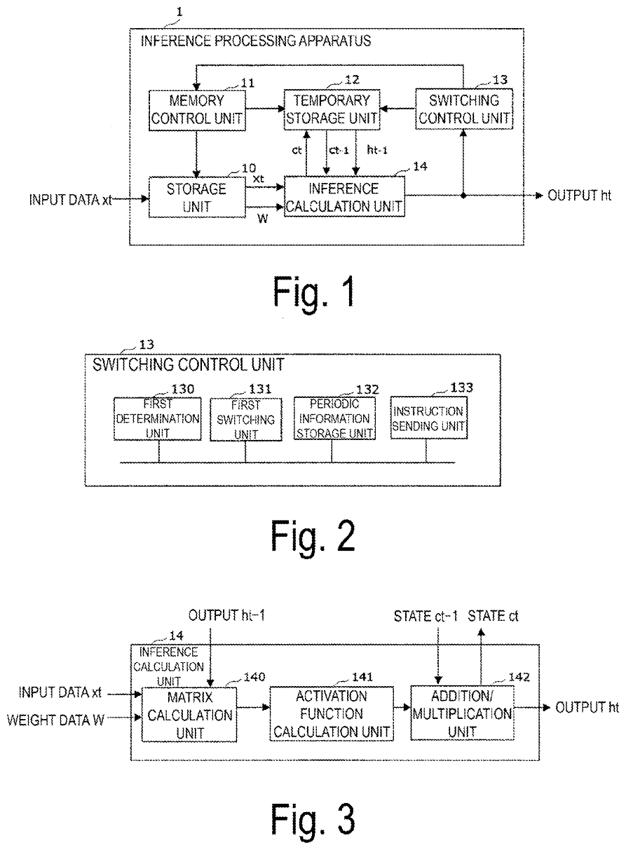

As illustrated in FIG. 2, the switching control unit 13 includes a first determination unit 130, a first switching unit 131, a periodic information storage unit 132, and an instruction sending unit 133.

The first determination unit 130 determines whether or not the first operation mode T_{M1} in which output feedback is performed or the second operation mode T_{M2} in which no output feedback is performed has ended based on a preset condition regarding the number of pieces of input data xₜ to be processed by the inference calculation unit 14.

For example, in each of the first operation mode T_{M1} and the second operation mode T_{M2}, a preset number of pieces of input data xₜ are processed by the inference calculation unit 14. For example, M₁ pieces of input data xₜ are processed in the first operation mode T_{M1} and M2 pieces of input data xₜ are processed in the second operation mode T_{M2}.

When the inference calculation unit 14 has processed all the preset M1 pieces of input data xₜ in the first operation mode T_{M1} in which output feedback is performed, the first determination unit 130 determines that the first operation mode T_{M1} has ended.

Further, when the inference calculation unit 14 has processed all the preset M2 pieces of input data xₜ in the second operation mode T_{M2} in which no output feedback is performed, the first determination unit 130 determines that the first operation mode T_{M1} has ended.

The first switching unit 131 generates a control signal indicating switching between the first operation mode T_{M1} in which output feedback is performed and the second operation mode T_{M2} in which no output feedback is performed based on the determination result of the first determination unit 130.

The periodic information storage unit 132 stores a period T_{M} (T_{M}=T_{M1}+T_{M2}) which is a preset unit of processing. The period T_{M} is set as a parameter, and for example, the period T_{M} and the first and second operation modes T_{M1} and T_{M2} constituting the period T_{M} can be set according to the inference accuracy of the inference result output by the inference processing apparatus 1. The period T_{M} may be dynamically set according to the input speed of the input data xₜ which is time series data. The period T_{M} may also be dynamically set based on a desired inference processing time. Further, the period T_{M} may be dynamically set based on the order dependence of the input data xₜ.

The amount or the number of pieces of input data xₜ to be processed by the inference calculation unit 14 in each of the first and second operation modes T_{M1} and T_{M2} constituting the period T_{M} stored in the periodic information storage unit 132 is set and stored in association with each of the operation modes T_{M1} and T_{M2}.

For example, the periodic information storage unit 132 stores information indicating the first operation mode T_{M1} in which output feedback is performed and M1 which is the number of pieces of input data xₜ to be processed by the inference calculation unit 14 in the first operation mode T_{M1} in association with each other. Similarly, the periodic information storage unit 132 stores information indicating the second operation mode T_{M2} in which no output feedback is performed and M2 which is the number of pieces of input data xₜ to be processed by the inference calculation unit 14 in the second operation mode T_{M2} in association with each other. For example, the number of pieces of data M2 to be processed in the second operation mode T_{M2} can be set larger than the number of pieces of data M1 to be processed in the first operation mode T_{M1}.

The instruction sending unit 133 sends a control signal indicating switching of the operation modes of output feedback generated by the first switching unit 131 to the memory control unit 11. For example, in the first operation mode T_{M1}, the instruction sending unit 133 sends a control signal indicating that the output hₜ from the inference calculation unit 14 is to be fed back to the inference calculation unit 14 to the memory control unit 11. When switching to the second operation mode T_{M2} has been performed, the instruction sending unit 133 sends a control signal indicating that the output hₜ is not to be fed back to the inference calculation unit 14 to the memory control unit 11.

More specifically, in the first operation mode T_{M1}, the instruction sending unit 133 sends an instruction to read input data xₜ from the storage unit 10 and an instruction to read an output hₜ₋₁ of the immediately previous time step from the temporary storage unit 12 to the memory control unit 11. That is, in the first operation mode T_{M1} in which output feedback is performed, the instruction sending unit 133 instructs the memory control unit 11 to read one piece of input data xₜ and input it to the inference calculation unit 14.

On the other hand, in the second operation mode T_{M2}, the instruction sending unit 133 instructs the memory control unit 11 to read a plurality of pieces of input data xₜ, . . . , x_{t+Batch-1} corresponding to a preset batch size (Batch) and weight data W corresponding to the plurality of pieces of input data from the storage unit 10 and transfer them to the inference calculation unit 14.

In the second operation mode T_{M2}, the instruction sending unit 133 instructs the memory control unit 11 only to write and read the state cₜ₋₁ of the memory cell to and from the temporary storage unit 12. That is, the instruction sending unit 133 instructs the memory control unit 11 not to write and read the output hₜ to and from the temporary storage unit 12.

In the first operation mode T_{M1}, the inference calculation unit 14 infers features of input data xₜ by performing calculation of the LSTM for each time step based on the input data xₜ, weight data W, an output hₜ₋₁ (a first value) indicating an inference result at an immediately previous time step, and a state cₜ₋₁ (a second value) of the memory cell which is an internal state of the LSTM at the immediately previous time step.

In the second operation mode T_{M2}, the inference calculation unit 14 infers features of input data xₜ by performing calculation of the LSTM for each time step based on the input data xₜ, weight data W, and a state cₜ₋₁ (a second value) of the memory cell which is an internal state of the LSTM at an immediately previous time step.

The inference calculation unit 14 obtains an output hₜ of the LSTM block at the current time step (t) as an inference result. More specifically, the inference calculation unit 14 performs an inference calculation of the LSTM in each operation mode according to the above equations (1) to (6).

As illustrated in FIG. 3, the inference calculation unit 14 includes a matrix calculation unit 140, an activation function calculation unit 141, and an addition/multiplication unit 142.

The matrix calculation unit 140 performs a matrix calculation of input data xₜ of each time step and weight data W for the input data xₜ. The matrix calculation unit 140 also performs a matrix calculation of an output hₜ₋₁ of an immediately previous time step and weight data W for the output hₜ₋₁. The calculation result of the matrix calculation unit 140 is input to the activation function calculation unit 141. More specifically, the matrix calculation unit 140 performs the product-sum calculations in parentheses in the above equations (1) to (4).

When the switching control unit 13 has performed switching to the first operation mode T_{M1} in which output feedback is performed, the matrix calculation unit 140 performs matrix product-sum calculations of a set of input data xₜ and corresponding weight data W and matrix product-sum calculations of an output hₜ₋₁ of an immediately previous step and weight data W.

On the other hand, when the switching control unit 13 has performed switching to the second operation mode T_{M2} in which no output feedback is performed, the matrix calculation unit 140 performs matrix product-sum calculations of pieces of input data xₜ to x_{t+Batch-1} corresponding to the batch size Batch and weight data W. In the second operation mode T_{M2}, the matrix calculation unit 140 does not perform matrix product-sum calculations of the output hₜ₋₁, and the weight data W. The batch size Batch is a preset value, which is a value in a range from 1 to the number of pieces of input data xₜ.

As illustrated in FIG. 3, the matrix calculation unit 140 includes a multiplier 40 and an adder 41.

The multiplier 41 multiplies input data xₜ and weight data W. The multiplier 40 also multiplies an output hₜ₋₁, of the immediately previous time step and weight data W.

The adder 41 adds the multiplication results of the multiplier 40 and outputs a matrix calculation result.

The activation function calculation unit 141 multiplies an activation function by an input from the matrix calculation unit 140 to determine how the sum of the matrix calculation results is activated. More specifically, the activation function calculation unit 141 applies an activation function to each element of a matrix calculation result to determine an activation output. The activation function is a sigmoid function or a tanh function.

Specifically, activation functions are applied to the results of the matrix product-sum calculations of the above equations (1) to (4) to obtain the respective outputs iₜ, fₜ, oₜ, and gₜ. A tanh function is also applied to the calculation of obtaining the output hₜ of the LSTM block shown in the above equation (6).

The addition/multiplication unit 142 performs element-wise addition and multiplication of the calculation results of the activation function calculation unit 141. More specifically, the addition/multiplication unit 142 performs element-wise addition and multiplication to calculate the state cₜ of the memory cell and the output hₜ of the LSTM block in the above equations (5) and (6).

The addition/multiplication unit 142 receives the state cₜ₋₁ of the memory cell of the immediately previous time step, which the memory control unit 11 has read from the temporary storage unit 12, as an input and calculates the state cₜ of the memory cell according to the above equation (5). The addition/multiplication unit 142 stores the state cₜ of the memory cell in the temporary storage unit 12. The addition/multiplication unit 142 inputs the output hₜ of the LSTM block to the switching control unit 13.

Hardware Configuration of Inference Processing Apparatus

Next, an example of a hardware configuration of the inference processing apparatus 1 configured as described above will be described with reference to FIG. 5.

As illustrated in FIG. 5, the inference processing apparatus 1 can be implemented, for example, by a computer including a processor 102, a main storage device 103, a communication interface 104, an auxiliary storage device 105, an input/output I/O 106, an input device 107, and a display device 108 which are connected via a bus 101 and a program that controls these hardware resources. Also, a sensor (not illustrated) may be connected to the inference processing apparatus 1 via the bus 101 to measure input data xₜ including time series data such as audio data for inference by the inference processing apparatus 1.

The main storage device 103 is implemented, for example, by semiconductor memories such as an SRAM, a DRAM, and a ROM. The main storage device 103 implements the storage unit 10, the temporary storage unit 12, and the periodic information storage unit 132 described above with reference to FIGS. 1 and 2.

The main storage device 103 stores in advance programs for the processor 102 to perform various controls and calculations. Each function of the inference processing apparatus 1 including the memory control unit ii, the switching control unit 13, and the inference calculation unit 14 illustrated in FIGS. 1 to 4 is implemented by the processor 102 and the main storage device 103.

The communication interface 104 is an interface circuit for communicating with various external electronic devices via a communication network NW. The inference processing apparatus 1 may receive weight data W of a trained neural network from the outside via the communication interface 104 or may send an output hₜ to the outside.

For example, an interface and an antenna compatible with a wireless data communication standard such as LTE, 3G, 5G, wireless LAN, or Bluetooth (registered trademark) are used as the communication interface 104. The communication network NW includes, for example, a wide area network (WAN), a local area network (LAN), the Internet, a dedicated line, a wireless base station, or a provider.

The auxiliary storage device 105 includes a readable and writable storage medium and a drive device for reading and writing various information such as programs, data, and the like from and to the storage medium. A semiconductor memory such as a hard disk or a flash memory can be used as a storage medium of the auxiliary storage device 105.

The auxiliary storage device 105 has a program storage area for storing a program for the inference processing apparatus 1 to perform switching of the operation modes relating to output feedback and a program for performing the inference calculation. Further, the auxiliary storage device 105 may have, for example, a backup area for backing up the data, programs, and the like described above.

The input/output I/O 106 includes I/O terminals for inputting a signal from an external device or outputting a signal to the external device.

The input device 107 includes a keyboard, a touch panel, or the like and generates and outputs a signal corresponding to a key press or a touch operation.

The display device io8 includes a display screen such as a liquid crystal display. The display device io8 can display, for example, an output hₜ that the inference processing apparatus 1 outputs through inference processing, an intermediate calculation result, input data xₜ, and the like.

The inference processing device 1 has a built-in clock (not illustrated). The built-in clock measures time and may use time information acquired, for example, from an NTP server. The inference processing of each time step is performed according to the time measured by the built-in clock.

The inference processing apparatus 1 may not only be implemented by one computer but may also be distributed over a plurality of computers connected to each other through the communication network NW. Further, the processor 102 may also be implemented by hardware such as a field-programmable gate array (FPGA), large scale integration (LSI), or an application specific integrated circuit (ASIC).

Inference Processing Method

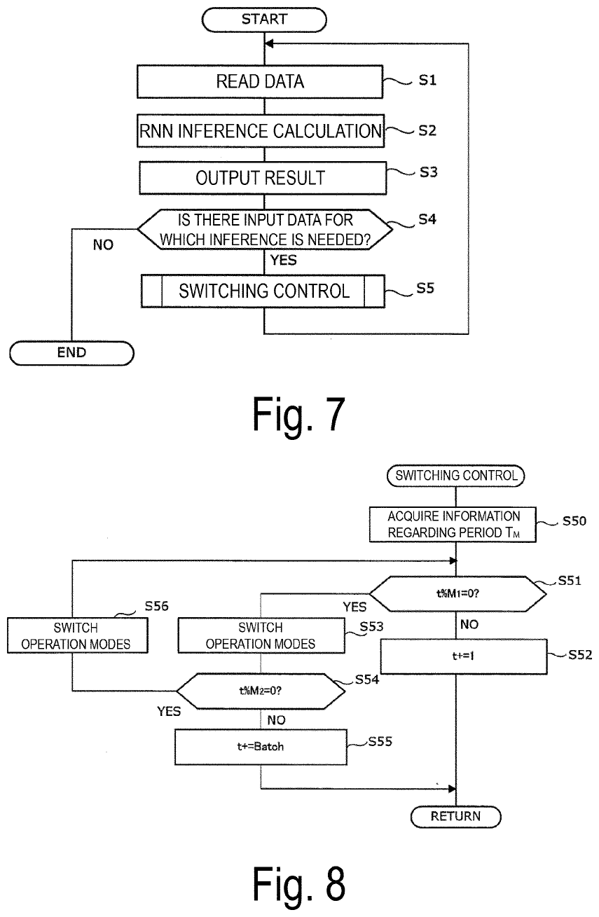

Next, an example of an operation of the inference processing apparatus 1 configured as described above will be described with reference to the explanatory diagram of FIG. 5 and flowcharts of FIGS. 6 and 7. The storage unit 10 is preloaded with a trained RNN model that has been trained and constructed through a calculation device such as an external server (not shown). An LSTM is used as an example of the RNN model.

It is assumed that information regarding the period T_{M}, which is a unit of processing used for controlling the switching of output feedback, is stored in the periodic information storage unit 132 in advance. Hereinafter, for the sake of simplicity, it is also assumed that, when inference processing starts, the inference calculation unit 14 performs the first operation mode T_{M1} in which output feedback is performed.

First, the memory control unit 11 reads data stored in the storage unit 10 and the temporary storage unit 12 (step S1). More specifically, the memory control unit 11 first reads input data xₜ and weight data W from the storage unit 10. The memory control unit 11 also reads an output hₜ₋₁ and a state cₜ₋₁ of the memory cell of an immediately previous time step from the temporary storage unit 12. The memory control unit 11 transfers the data read from the storage unit 10 and the temporary storage unit 12 to the inference calculation unit 14.

Next, in the first operation mode T_{M1}, the inference calculation unit 14 takes the input data xₜ, the weight data W, the output hₜ₋₁, of the immediately previous time step, and the state cₜ₋₁ of the memory cell of the immediately previous time step as inputs and performs inference calculation of the LSTM according to the above equations (1) to (6) (step S2). More specifically, the inference calculation unit 14 processes Mi pieces of input data xₜ at time steps in the first operation mode T_{M1}.

Thereafter, an output hₜ of the LSTM block is output as a result of the inference calculation and the output hₜ is also passed to the switching control unit 13 for output feedback (step S3). More specifically, the inference calculation unit 14 outputs the output hₜ of the LSTM block corresponding to the input data xₜ for each time step. Further, each output hₜ is subjected to output feedback for the inference calculation of the next time step, and thus the inference calculation unit 14 processes the M1 pieces of input data xₜ.

Next, when the storage unit 10 contains input data xₜ which has not been processed for inference by the inference calculation unit 14 (step S4: YES), the switching control unit 13 performs switching control of the operation modes of output feedback (step S5). Specifically, the switching control unit 13 performs switching control when the M1 pieces of input data xₜ which are to be processed in the first operation mode T_{M1} have been processed with M2 pieces of input data xₜ remaining in the storage unit 10.

On the other hand, the process ends when the storage unit 10 does not have input data xₜ for which inference is needed (step S4: NO). Specifically, the process ends when inference processing has been performed for all of a total of M pieces of input data xₜ where M=M1+M2.

Here, an example of the switching control of the operation modes of output feedback (step S5 in FIG. 7) performed by the switching control unit 13 will be described with reference to the flowchart of FIG. 8.

First, the first determination unit 130 acquires information regarding the period T_{M}, which is a unit of processing for switching control between the first operation mode T_{M1} and the second operation mode T_{M2}, from the periodic information storage unit 132 (step S50).

For example, the information regarding the period T_{M} includes information indicating each of the first operation mode T_{M1} and the second operation mode T_{M2} and the number of pieces of input data xₜ to be processed by the inference calculation unit 14 in each of the operation modes. Here, the first determination unit 130 may determine that the operation mode of the immediately previous time step is the first operation mode T_{M1} when information regarding the output hₜ has been transferred from the inference calculation unit 14.

Next, the first determination unit 130 determines whether or not the inference calculation unit 14 has processed all M1 pieces of input data xₜ in the first operation mode T_{M1} in which output feedback is performed and thus the first operation mode T_{M1} has ended (step S51).

Specifically, when there is unprocessed data out of the M1 pieces of data that are to be processed by the inference calculation unit 14 in the first operation mode T_{M1} in which output feedback is performed (t % M₁≠o where t represents the time step and % represents a remainder) (step S51: NO), the first determination unit 130 increments the time step (t+=1) (step S52). Thereafter, the process returns to step S1 of FIG. 7 and steps S1 to S4 are repeated again with output feedback (in the first operation mode T_{M1}).

For example, as illustrated in FIG. 6, in the hatched first operation mode T_{M1} which is the first half of the period T_{M}, the inference calculation unit 14 performs output feedback to perform inference processing for the M₁ pieces of input data xₜ.

In the first operation mode T_{M1} which is the first half of the period T_{M}, the inference calculation unit 14 performs output feedback to perform inference processing for pieces of input data xₜ serially one by one as described above.

On the other hand, when the M1 pieces of input data xₜ for which output feedback is to be performed for inference processing have all been processed (t % M1=o) and the first operation mode T_{M1} has ended (step S51: YES), the first switching unit 131 switches the operation mode of the inference calculation unit 14 to the second operation mode T_{M2} (step S53). More specifically, the first switching unit 131 generates an instruction not to perform output feedback and the instruction sending unit 133 sends a control signal instructing not to read and write the outputs hₜ and hₜ₋₁ from and to the temporary storage unit 12 to the memory control unit 11.

Next, the first determination unit 130 determines whether or not the inference calculation unit 14 has processed all M2 pieces of input data xₜ in the second operation mode T_{M2} and thus the second operation mode T_{M2} has ended (step S54).

Specifically, when there is unprocessed data out of the M2 pieces of input data xₜ which are to be processed by the inference calculation unit 14 in the second operation mode T_{M2} in which no output feedback is performed (t % M2≠o) (step S54: NO), the first determination unit 130 increments the time step (t+=Batch) (step S55). Thereafter, the process returns to step S1 and steps S1 to S4 are repeated in the second operation mode T_{M2} in which no output feedback is performed.

On the other hand, upon determining that the inference calculation unit 14 has processed all M2 pieces of input data xₜ to x_{t+Batch-1} which are to be processed in the second operation mode T_{M2} (t % M2=o) (step S54: YES), the first determination unit 130 performs switching to the first operation mode T_{M1} in which output feedback is performed (step S56).

Hereinafter, the process of steps S1 to S4 in the second operation mode T_{M2} in which no output feedback is performed will be described (FIG. 7).

First, the memory control unit 11 reads pieces of input data xₜ to x_{t+Batch-1} corresponding to a set batch size Batch and corresponding weight data W from the storage unit 10 based on a control signal from the instruction sending unit 133 and transfers them to the inference calculation unit 14 (step S1). The memory control unit 11 also reads a state cₜ₋₁ of the memory cell of an immediately previous time step from the temporary storage unit 12 and inputs it to the inference calculation unit 14 (step S1). For example, when the batch size Batch is three, the memory control unit 11 reads three pieces of input data xₜ, xₜ₊₁, and xₜ₊₂ from the storage unit 10.

Next, the inference calculation unit 14 performs inference calculation according to the above equations (1) to (6) based on Batch pieces of input data xₜ to x_{t+Batch-1}, weight data W, and the state cₜ₋₁ of the memory cell of the immediately previous time step which have been transferred thereto by the memory control unit ii (step S2). Here, the matrix calculation unit 140 does not perform product-sum calculations on the output hₜ₋₁.

Thereafter, the inference calculation unit 14 outputs a result hₜ of the inference calculation (step S3). Specifically, the inference calculation unit 14 outputs hₜ to h_{t+Batch-1} corresponding to the Batch pieces of input data in order.

For example, as illustrated in FIG. 6, the switching control unit 13 performs switching from the first operation mode T_{M1} in which output feedback is performed to the second operation mode T_{M2} in which no output feedback is performed. The switching control unit 13 alternately switches between the first operation mode T_{M1} and the second operation mode T_{M2} with the period T_{M} as one unit of processing until inference processing is performed for all pieces of input data xₜ stored in the storage unit 10.

Because the switching control unit 13 allows output feedback to be performed at some intervals in the inference calculation of the inference calculation unit 14 as described above, the inference calculation unit 14 can perform batch processing of pieces of input data xₜ in the second operation mode T_{M2} in which no output feedback is performed.

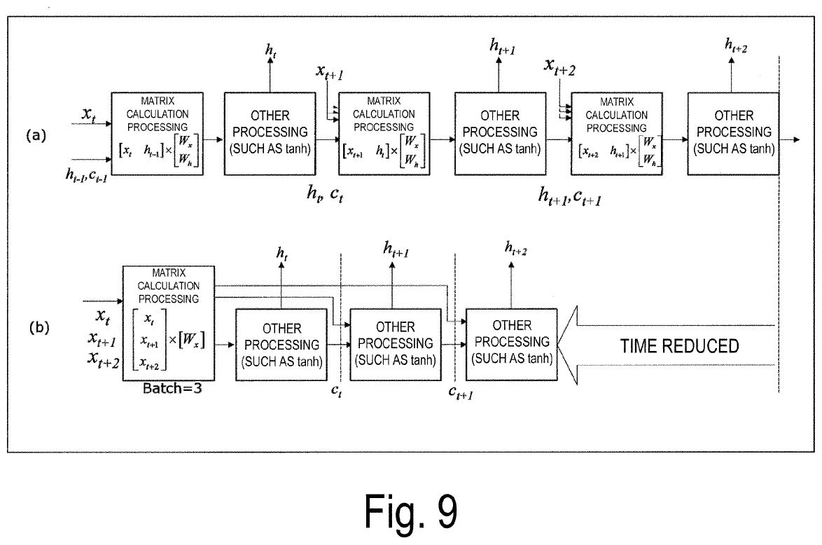

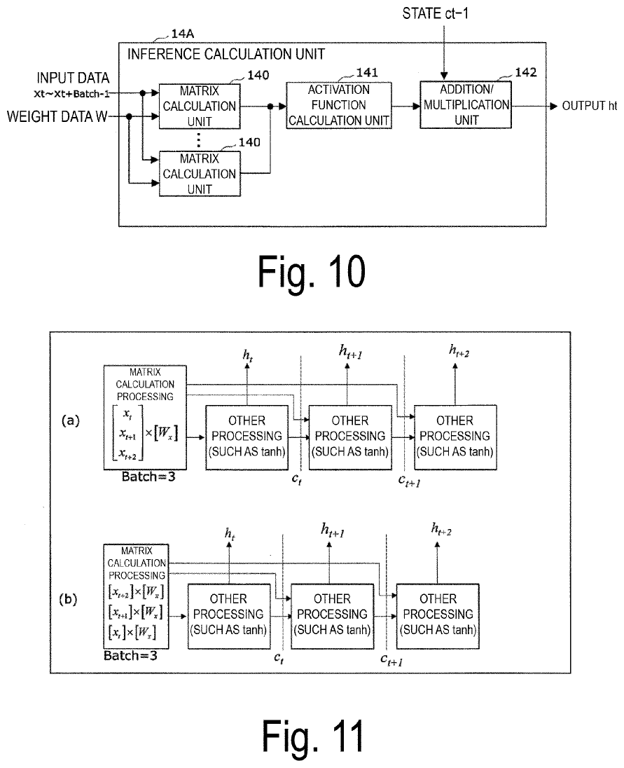

Next, advantages of the inference processing apparatus 1 according to the present embodiment will be described with reference to FIG. 9. FIG. 9(a) illustrates inference processing of the inference calculation unit 14 in the first operation mode T_{M1} in which output feedback is performed.

As illustrated in FIG. 9(a), pieces of input data xₜ are processed one by one, one output hₜ is obtained for each time step, and the output hₜ is fed back as an input for inference calculation at the next time step. In this manner, the pieces of input data xₜ are serially processed in the first operation mode T_{M1}.

On the other hand, as illustrated in FIG. 9(b), in the second operation mode T_{M2} in which no output feedback is performed, matrix calculations can be batch-processed and thus matrix calculations of a plurality of pieces of input data xₜ to x_{t+Batch-1} can be performed. Therefore, in the second operation mode T_{M2}, the processing time of the inference calculation can be reduced as compared to the first operation mode T_{M1} in which output feedback is performed.

As described above, the inference processing apparatus 1 according to the first embodiment switches the operation modes such that output feedback is performed at regular intervals and thus can batch-process a plurality of pieces of input data in the operation mode in which no output feedback is performed. Therefore, the inference processing apparatus 1 can reduce the processing time of the inference calculation.

The above embodiment has been described with reference to the case where inference processing is performed using an LSTM as an example of an RNN. However, the present embodiment can be applied to recurrent neural networks that perform feedback processing in inference calculation such as deep RNNs, bidirectional RNNs, RCNNs, MDRNNs, bidirectional LSTMs, and GRUs in addition to LSTMs.

The above embodiment has also been described with reference to the case where the first determination unit 130 performs switching from the first operation mode T_{M1} to the second operation mode T_{M2} based on whether or not inference processing has been performed for all of a number of (M₁) pieces of input data xₜ associated with the first operation mode T_{M1} as an example. However, for example, the processing time during which inference processing is performed may be used as a condition for the first determination unit 130 to make a determination on the switching of operation modes. For example, estimates such as the respective processing speeds of the inference processing apparatus 1 in the first and second operation modes T_{M1} and T_{M2} can be obtained in advance based on the hardware used, the clock frequency, the bit accuracy of processing calculation, or the like.

### Second Embodiment

Next, a second embodiment of the present invention will be described. In the following description, the same components as those in the first embodiment described above will be denoted by the same reference signs and description thereof will be omitted.

The first embodiment has been described with reference to the case where one matrix calculation unit 140 performs matrix calculations. In contrast, in the second embodiment, an inference calculation unit 14A is provided with a plurality of matrix calculation units 140 to perform matrix calculations in parallel.

FIG. 10 is a block diagram illustrating a configuration of the inference calculation unit 14A according to the present embodiment.

For example, K matrix calculation units 140 are provided (where K is an integer of 2 or more and the batch size (Batch) or less, Batch being 2 or more).

For example, when there is one piece of input data xₜ, the matrix calculation performed by the matrix calculation unit 140 is [xₜ]×[Wₓ]. When the number of pieces of input data xₜ is Batch, the single matrix calculation unit 140 needs to serially process matrix calculations [xₜ]×[Wₓ], [xₜ₊₁]×[Wₓ], [xₜ₊₂₊₂]×[Wₓ], . . . [x_{t+Batch-1}]×[Wₓ]. That is, when the number of pieces of input data is Batch, the matrix calculation unit 140 repeats the matrix calculation Batch times to complete the entire matrix calculations.

When the switching control unit 13 has performed switching from the first operation mode T_{M1} in which output feedback is performed to the second operation mode T_{M2} in which no output feedback is performed, the matrix calculation unit 140 performs matrix calculations of pieces of input data x_{t+Batch-1} and weight data W for the pieces of input data. In the present embodiment, the K matrix calculation units 140 perform matrix calculations that need to be repeated Batch times in K parallel branches. For example, when K=Batch, matrix calculations for all pieces of input data xₜ to x_{t+Batch-1} can be processed at one time.

FIG. 11 illustrates the case where one matrix calculation unit 140 performs batch processing of pieces of input data xₜ to x_{t+Batch-1} in the second operation mode T_{M2} in which no output feedback is performed (FIG. 11(a)) and the case where K matrix calculation units 140 perform the same (FIG. 11(b)). In the example of FIG. 11, the batch size Batch is three. The example of FIG. 11(b) illustrates the case of three matrix calculation units 140 (Batch=K=3).

As illustrated in FIG. 11(a), it is necessary for one matrix calculation unit 140 to repeat the matrix calculation three times. In contrast, in the present embodiment having K matrix calculation units 140 (Batch=K=3), there is no need to repeat the matrix calculation because three matrix calculations are processed in parallel as illustrated in FIG. 11(b).

According to the second embodiment, the K matrix calculation units 140 are provided to perform batch processing of pieces of input data in parallel in the second operation mode T_{M2} in which no output feedback is performed as described above, such that repetition of matrix calculations can be reduced and the processing time of matrix calculations can be reduced. As a result, the total processing time of the inference processing apparatus 1 can be reduced.

### Third Embodiment

Next, a third embodiment of the present invention will be described. In the following description, the same components as those in the first and second embodiments described above will be denoted by the same reference signs and description thereof will be omitted.

The first and second embodiments have been described with reference to the case where the switching control unit 13 alternately and consecutively switches between the first operation mode T_{M1} in which output feedback is performed in the inference calculation unit 14 and the second operation mode T_{M2} in which no output feedback is performed. In contrast, in the third embodiment, in addition to the switching control of the operation modes of output feedback, the same switching control is performed for the feedback of the state cₜ of the memory cell.

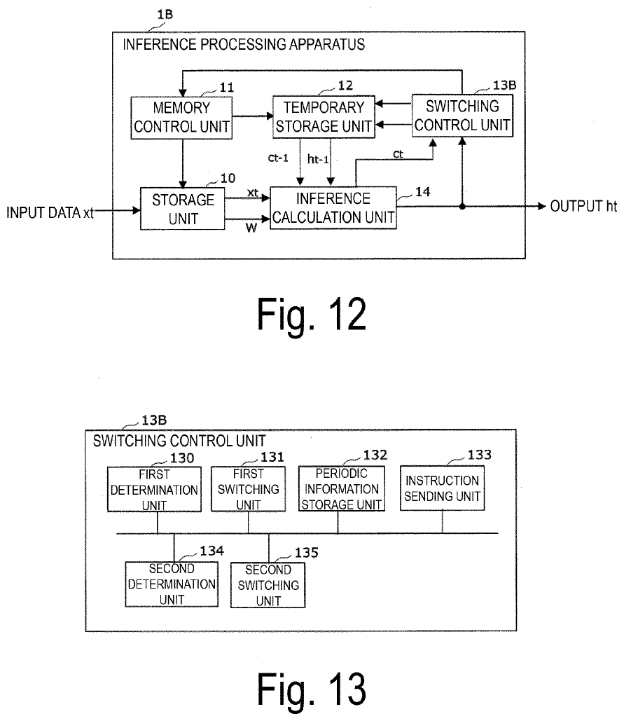

FIG. 12 is a block diagram illustrating a configuration of an inference processing apparatus 1B according to the present embodiment. The inference processing apparatus 1B includes a storage unit 10, a memory control unit 11, a temporary storage unit 12, a switching control unit (a first switching control unit and a second switching control unit) 13B, and an inference calculation unit 14. In the inference processing apparatus 1B, a state cₜ of the memory cell obtained through inference calculation of the inference calculation unit 14 is input to the switching control unit 13B.

Similar to the first embodiment, the switching control unit 13B performs control such that feedback of the output hₜ is performed at some intervals in the inference calculation of the inference calculation unit 14 based on a preset period T_{M} which is a unit of processing. In addition to this, the switching control unit 13B performs control such that feedback of the state cₜ of the memory cell (a second value) to the inference calculation unit 14 is performed at some intervals based on a preset period T_{N} (T_{N}=T_{N1}+T_{N2}) which is a unit of processing.

More specifically, the switching control unit 13B performs control to alternately switch between a third operation mode (hereinafter referred to as a “third operation mode T_{N1}”) in which a state cₜ₋₁ of the memory cell of an immediately previous time step is used for inference calculation in the inference calculation unit 14 and a fourth operation mode (hereinafter referred to as a “fourth operation mode T_{N2}”) in which the state cₜ₋₁ of the memory cell of the immediately previous time step is not used for inference calculation in the inference calculation unit 14.

Hereinafter, the state cₜ₋₁ of the memory cell of the immediately previous time step being input for the inference calculation in the inference calculation unit 14 is referred to as “state feedback.”

FIG. 13 is a block diagram illustrating a configuration of the switching control unit 13B. The switching control unit 13B includes a first determination unit 130, a first switching unit 131, a periodic information storage unit 132, an instruction sending unit 133, a second determination unit 134, and a second switching unit 135. Hereinafter, components different from those of the switching control unit 13 according to the first and second embodiments will be mainly described.

The second determination unit 134 determines whether or not the third operation mode T_{N1} in which state feedback is performed or the fourth operation mode T_{N2} in which no state feedback is performed has ended based on a preset condition regarding the number of pieces of input data xₜ to be processed by the inference calculation unit 14.

For example, the periodic information storage unit 132 stores the period T_{N} (T_{N}=T_{N1}+T_{N2}) which is a unit of processing for state feedback. The periodic information storage unit 132 also stores information indicating the third operation mode T_{N2} and the number of pieces of input data xₜ to be processed by the inference calculation unit 14 in the third operation mode T_{N1} (for example, N1) in association with each other.

Further, the periodic information storage unit 132 stores information indicating the fourth operation mode T_{N2} and the number of pieces of input data xₜ to be processed by the inference calculation unit 14 in the fourth operation mode T_{N2} (for example, N2) in association with each other. Details of the period T_{N} (T_{N}=T_{N1}+T_{N2}) which is a unit of processing for state feedback will be described later.

The second determination unit 134 determines that the third operation mode T_{N1} has ended when the inference calculation unit 14 has processed all N1 pieces of input data xₜ which are to be processed in the third operation mode T_{N1} in which state feedback is performed based on the information regarding the period T_{N} for the state feedback. Further, the second determination unit 134 determines that the fourth operation mode T_{N2} has ended when the inference calculation unit 14 has processed all N2 pieces of input data xₜ which are to be processed in the fourth operation mode T_{N2} in which no state feedback is performed.

The second switching unit 135 generates a control signal indicating switching between the third operation mode T_{N1} in which state feedback is performed in the inference calculation of the inference calculation unit 14 and the fourth operation mode T_{N2} in which no state feedback is performed based on the determination result of the second determination unit 134.

The periodic information storage unit 132 stores the preset period TN which is a unit of processing for state feedback. The periodic information storage unit 132 also stores the period T_{M} which is a unit of processing for output feedback, similar to the first and second embodiments.

The periods T_{N} and T_{M} are set as parameters, and for example, the periods T_{N} and T_{M} can be set according to the inference accuracy of the inference result output by the inference processing apparatus 1. The periods T_{N} and T_{M} may be dynamically set according to the input speed of the input data xₜ which is time series data. The periods T_{N} and T_{M} may also be dynamically set based on a desired inference processing time. Further, the periods T_{N} and T_{M} may be dynamically set based on the order dependence of the input data xₜ.

The same value may be used for the periods T_{N} and T_{M}. That is, the numbers of pieces of input data xₜ to be processed in the periods T_{N} and T_{M} may be the same (N=M) or different (N≠M) and can also be set arbitrarily.

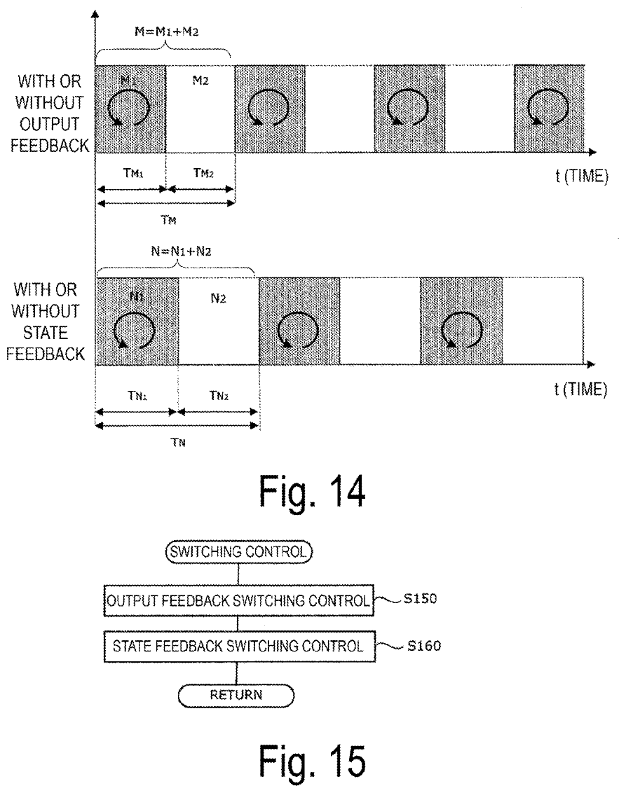

As illustrated in FIG. 14, the period T_{N} which is a unit of processing for state feedback includes the third operation mode T_{N1} in which state feedback is performed in the inference calculation of the inference calculation unit 14 and the fourth operation mode T_{N2} in which no state feedback is performed. The third and fourth operation modes T_{N1} and T_{N2} are performed alternately and consecutively as illustrated in FIG. 14.

The instruction sending unit 133 sends a control signal corresponding to switching of the operation modes of output feedback generated by the first switching unit 131 to the memory control unit 11. The instruction sending unit 133 also sends a control signal corresponding to switching of the operation modes of state feedback generated by the second switching unit 135 to the memory control unit 11.

Specifically, when output feedback is performed in the inference calculation of the inference calculation unit 14 (in the first operation mode T_{M1}) as illustrated in FIG. 14, the instruction sending unit 133 instructs the memory control unit 11 to read one piece of input data xₜ and corresponding weight data W from the storage unit 10 and transfer them to the inference calculation unit 14.

Here, consider the case where output feedback is performed in the inference calculation of the inference calculation unit 14 (in the first operation mode T_{M1}) and state feedback is performed (in the third operation mode T_{N1}) as illustrated in FIG. 14. In this case, the instruction sending unit 133 instructs the memory control unit 11 to write both a state cₜ and an output hₜ of the LSTM block to the temporary storage unit 12 and read a state cₜ₋₁ and an output hₜ₋₁ therefrom.

Further, when output feedback is performed in the inference calculation of the inference calculation unit 14 (in the first operation mode T_{M1}) and no state feedback is performed (in the fourth operation mode T_{N2}), the instruction sending unit 133 sends, to the memory control unit 11, an instruction to write an output hₜ of the LSTM block and read an output hₜ₋₁ to and from the temporary storage unit 12 and not to write and read states cₜ and cₜ₋₁.

On the other hand, when no output feedback is performed in the inference calculation of the inference calculation unit 14 (in the second operation mode T_{M2}), the instruction sending unit 133 instructs the memory control unit 11 to read pieces of input data xₜ to x_{t+Batch-1} corresponding to a preset batch size (Batch) and corresponding weight data W from the storage unit 10 and transfer them to the inference calculation unit 14.

Further, consider the case where no output feedback is performed in the inference calculation of the inference calculation unit 14 (in the second operation mode T_{M2}) and state feedback is performed (in the third operation mode T_{N1}). In this case, the instruction sending unit 133 sends, to the memory control unit 11, an instruction to write the state cₜ and read the state cₜ₋₁ to and from the temporary storage unit 12 and not to write and read the outputs hₜ and hₜ₋₁ of the LSTM block.

Further, when no output feedback is performed in the inference calculation of the inference calculation unit 14 (in the second operation mode T_{M2}) and no state feedback is performed (in the fourth operation mode T_{N}2), the instruction sending unit 133 sends, to the memory control unit 11, an instruction not to write and read any of the states cₜ and cₜ₋₁ and the outputs hₜ and hₜ₋₁ of the LSTM block to and from the temporary storage unit 12.

Inference Calculation Unit

The inference calculation unit 14 performs the inference calculation of the LSTM according to the above equations (1) to (6) based on the input data xₜ and the weight data W that have been input according to the switching control of the operation modes of output feedback and state feedback by the switching control unit 13B. Hereinafter, the inference calculation of the inference calculation unit 14 according to combinations of an operation mode of output feedback and an operation mode of state feedback will be described.

Inference Calculation Unit: First Operation Mode T_{M1}

First, when output feedback is performed (in the first operation mode T_{M1}), the matrix calculation unit 140 performs product-sum calculations based on one piece of input data xₜ, weight data W, and an output hₜ₋₁ of an immediately previous step (equations (1) to (4)).

The activation function calculation unit 141 applies activation functions to the matrix calculation results of the matrix calculation unit 140 to determine how the matrix calculation results are activated (equations (1) to (4)). The calculation of the activation function calculation unit 141 is the same for any combination of operation modes.

The addition/multiplication unit 142 performs element-wise addition and multiplication on the results determined by the activation function calculation unit 141 (equations (5) and (6)) to obtain an output hₜ of the LSTM block. Here, when no state feedback is performed (in the fourth operation mode T_{N2}), the addition/multiplication unit 142 does not perform calculations relating to the state cₜ₋₁ of the immediately previous time step.

Inference Calculation Unit: Second Operation Mode T_{M2}

When no output feedback is performed (in the second operation mode T_{M2}), the matrix calculation unit 140 performs matrix calculations of pieces of input data xₜ to x_{t+Batch-1} corresponding to a preset batch size (Batch) and corresponding weight data W (equations (1) to (4), excluding product-sum calculations relating to the output hₜ₋₁ of the immediately previous step).

Inference Calculation Unit: Second Operation Mode T_{M2} and Third Operation Mode Tm

Next, consider the case where no output feedback is performed in the inference calculation of the inference calculation unit 14 (in the second operation mode T_{M2}) while state feedback is performed (in the third operation mode T_{N1}).

The addition/multiplication unit 142 performs element-wise multiplication and addition using the state cₜ₋₁ of the immediately previous step on the results of applying activation functions to the matrix calculation results to which the activation function calculation unit 141 has applied activation functions to obtain an output hₜ of the LSTM block. Here, the output hₜ is not fed back.

Inference Calculation Unit: Second Operation Mode T_{M2} and Fourth Operation Mode T_{N2}

On the other hand, the inference calculation in the inference calculation unit 14 when no output feedback is performed (in the second operation mode T_{M2}) and no state feedback is performed (in the fourth operation mode T_{N2}) will be described below with regard to points different from those of the cases of the above combinations of operation modes.

In this case, the addition/multiplication unit 142 obtains the output hₜ of the LSTM block without performing calculations relating to the state cₜ₋₁ of the immediately previous step in the element-wise multiplication and addition of results obtained by applying activation functions. Also, the output hₜ is not fed back.

Switching Control

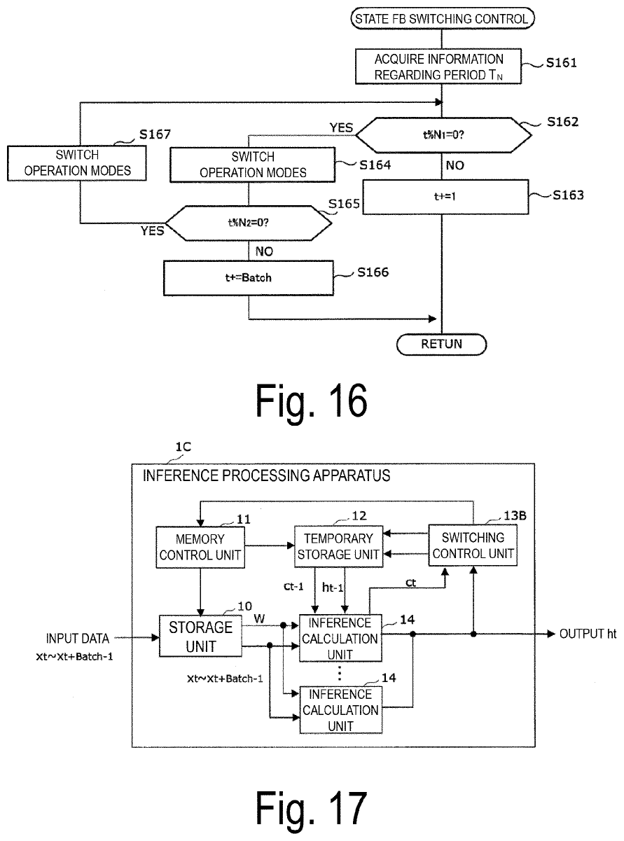

Next, switching control of the operation modes in the inference processing apparatus 1B configured as described above will be described with reference to flowcharts of FIGS. 15 and 16. The overall operation of the inference processing apparatus 1B is the same as that of the procedure described with reference to FIG. 7.

In the following, it is assumed as a premise that the inference calculation unit 14 is performing inference calculation in the first operation mode T_{M1} in which output feedback is performed and the third operation mode T_{N1} in which state feedback is performed.

First, the switching control unit 13B controls switching from the first operation mode T_{M1} to the second operation mode T_{M2} in which no output feedback is performed (step S150). More specifically, the switching control unit 13B performs control to alternately switch between the first operation mode T_{M1} and the second operation mode T_{M2}. The switching control between the first operation mode T_{M1} and the second operation mode T_{M2} by the switching control unit 13B is the same as in the process (of steps S50 to S55) described with reference to FIG. 8.

Next, the switching control unit 13B controls switching from the third operation mode T_{N1} to the fourth operation mode T_{N2} in which no state feedback is performed (step S160). More specifically, the switching control unit 13B performs control to alternately switch between the third operation mode T_{N1} and the fourth operation mode T_{N2}.

The switching control of the operation modes of output feedback (step S150) and the switching control of the operation modes of state feedback (step S160) may be performed independently of each other as described above.

State Feedback Switching Control

Next, the switching control of the operation modes of state feedback will be described in more detail with reference to the flowchart of FIG. 16. In the following, it is assumed that the same value is used for the period T_{M} which is a unit of processing used in the switching control of the operation modes of output feedback and the period T_{N} which is a unit of processing used in the switching control of the operation modes of state feedback (T_{M}=T_{N}, T_{M1}=T_{N1}, and T_{M2}=T_{N2})

First, the second determination unit 134 acquires information regarding the period T_{N} which is a unit of processing of state feedback switching control from the periodic information storage unit 132 (step S161). Next, the second determination unit 134 determines whether or not all N1 pieces of input data xₜ have been processed in the third operation mode T_{N1} in which state feedback is performed and thus the third operation mode T_{N1} has ended (step S161).

Specifically, when all N1 pieces of input data xₜ which are to be processed by the inference calculation unit 14 in the third operation mode T_{N1} have not been processed (t % N1≠o) (step S161: NO), the second determination unit 134 increments the time step (step S162). Thereafter, the process returns to step S1 of FIG. 7 and the process of steps S1 to S4 is repeated again.

Thereafter, when the inference calculation unit 14 has performed calculation processing on all N1 pieces of input data xₜ in the third operation mode T_{N1} in which feedback of the state cₜ is performed (t % N1=o) (step S161: YES), the second switching unit 135 performs switching to the fourth operation mode T_{N2} in which no state feedback is performed (step S163).

More specifically, the second switching unit 135 generates a control signal for switching from the third operation mode Tm to the fourth operation mode T_{N2}. The instruction sending unit 133 sends the control signal to the memory control unit 11. The memory control unit 11 does not write the state cₜ or read the state cₜ₋₁ to or from the temporary storage unit 12 according to the control instruction.

When the second determination unit 134 has determined that the inference calculation unit 14 has processed all N2 pieces of input data xₜ to x_{t+Batch-1} which are to be processed in the fourth operation mode T_{N2} (step S165: YES), the second switching unit 135 performs switching to the third operation mode T_{N1} in which state feedback is performed (step S167).

As described above, the inference processing apparatus 1B according to the third embodiment performs the switching control of the operation modes in which state feedback is performed at some intervals in addition to the control to perform output feedback at some intervals. Thus, it is possible to reduce calculations required for updating the state cₜ in the operation mode in which no state feedback is performed in the inference calculation of the inference calculation unit 14. The entire processing time of inference processing can be reduced because the time required to read the state cₜ₋₁ from the temporary storage unit 12 and the time required to write the state cₜ can be reduced.

### Fourth Embodiment

Next, a fourth embodiment of the present invention will be described. In the following description, the same components as those in the first to third embodiments described above will be denoted by the same reference signs and description thereof will be omitted.

The first to third embodiments have been described with reference to the case where one inference calculation unit 14 performs inference calculations. In contrast, in the fourth embodiment, a plurality of inference calculation units 14 process inference calculations in parallel.

FIG. 17 is a block diagram illustrating a configuration of an inference processing apparatus 1C according to the present embodiment. The inference processing apparatus 1C includes a storage unit 10, a memory control unit 11, a temporary storage unit 12, a switching control unit 13B, and a plurality of inference calculation units 14. The configurations of the functional units included in the inference processing apparatus 1C according to the present embodiment are the same as those of the third embodiment.

K inference calculation units 14 are provided (where K is an integer of 2 or more and Batch or less). In the case of the second operation mode T_{M2} in which no output feedback is performed, the inference calculation units 14 perform inference calculations based on pieces of input data xₜ to x_{t+Batch-1} and weight data W for the pieces of input data.

For example, when the number of pieces of input data is Batch, the inference calculations are completed by repeating the calculations of the matrix calculation unit 140, the activation function calculation unit 141, and the addition/multiplication unit 142 Batch times. In the present embodiment, K inference calculation units 14 process Batch pieces of input data xₜ to x_{t+Batch-1} in K parallel branches.

In the second operation mode T_{M2} in which no output feedback is performed, the inference calculation unit 14 performs batch processing, while when no state feedback is performed (in the fourth operation mode T_{N2}) in addition to this, inference calculations can further be reduced and the processing time of inference calculation can further be shortened.

According to the fourth embodiment, the processing time of inference calculation can be reduced because a plurality of inference calculation units 14 process inference calculations in parallel as described above.

In the above embodiments, while output feedback and state feedback are performed at some intervals, the period T_{M} which is a unit of processing of output feedback switching control or the period T_{N} which is a unit of processing of state feedback switching control can be adjusted based on the inference accuracy of the inference result output from the inference processing apparatus 1 to limit deterioration of the inference accuracy and reduce the time of inference processing. For example, the number of pieces of input data xₜ to be processed in the second operation mode T_{M2} in which no output feedback is performed or the number of pieces of input data xₜ to be processed in the fourth operation mode T_{N2} in which no state feedback is performed can be reduced when the inference accuracy has fallen below a certain value.

The first to fourth embodiments described above can also be combined with each other.

Although embodiments of the inference processing apparatus and the inference processing method of the present invention have been described above, the present invention is not limited to the described embodiments and various modifications conceivable by those skilled in the art can be made within the scope of the invention described in the claims.

For example, each functional unit other than the inference calculation unit in the inference processing apparatus of the present invention can be implemented by a computer and a program, and the program can be recorded on a recording medium or provided through a network.

Reference Signs List

1 Inference processing apparatus

10 Storage unit

11 Memory control unit

12 Temporary storage unit

13 Switching control unit

14 Inference calculation unit

130 First determination unit

131 First switching unit

132 Periodic information storage unit

133 Instruction sending unit

140 Matrix calculation unit

141 Activation function calculation unit

142 Addition/multiplication unit

40 Multiplier

41 Adder

101 Bus

102 Processor

103 Main storage device

104 Communication interface

105 Auxiliary storage device

106 Input/output I/O

107 Input device

108 Display device.

1-8. (canceled)

9. An inference processing apparatus comprising:
an inference calculator configured to perform calculation of a neural network based on input data of each of consecutive time steps and a weight of a trained neural network to infer a feature of the input data;
a first memory configured to store the input data;
a second memory configured to store the weight;
a third memory configured to store a first value relating to an inference result of the neural network; and
a first switching controller configured to control switching between a first operation mode in which the inference calculator performs calculation of the neural network based on the input data, the weight, and the first value at each of the consecutive time steps and a second operation mode in which the inference calculator performs calculation of the neural network based on the input data and the weight at each of the consecutive time steps,
wherein the first value is an inference result obtained by the inference calculator at an immediately previous time step of the consecutive time steps.

10. The inference processing apparatus according to claim 9, wherein the first switching controller includes:
a first determination device configured to determine whether or not the first operation mode or the second operation mode has ended based on a preset condition regarding a number of pieces of input data to be processed by the inference calculator; and
a first switch configured to generate a control signal indicating switching between the first operation mode and the second operation mode based on a determination result of the first determination device.

11. The inference processing apparatus according to claim 10, further comprising a memory controller configured to read the input data corresponding to a preset batch size from the first memory when the control signal indicates switching to the second operation mode,
wherein the inference calculator is configured to batch-process calculations of the neural network based on the input data corresponding to the preset batch size and the weight in the second operation mode to infer a feature of the input data.

12. The inference processing apparatus according to claim 9, further comprising:
a fourth memory configured to store a second value relating to an internal state of an intermediate layer of the neural network; and
a second switching controller configured to control switching between a third operation mode in which the inference calculator performs calculation of the neural network using the second value at each of the consecutive time steps and a fourth operation mode in which the inference calculator performs calculation of the neural network without using the second value at each of the consecutive time steps,
wherein the second value is an internal state of the intermediate layer of the neural network at an immediately previous time step of the consecutive time steps.

13. The inference processing apparatus according to claim 12, wherein the second switching controller includes:
a second determination device configured to determine whether or not the third operation mode or the fourth operation mode has ended based on a preset condition regarding a number of pieces of input data to be processed by the inference calculator; and
a second switch configured to generate a control signal indicating switching between the third operation mode and the fourth operation mode based on a determination result of the second determination device.

14. The inference processing apparatus according to claim 9, wherein the inference calculator includes a plurality of inference calculators configured to perform calculations of the neural network in parallel.

15. The inference processing apparatus according to claim 9, wherein the neural network is a recurrent neural network.

16. An inference processing method for performing calculation of a neural network based on input data of each of consecutive time steps and a weight of a trained neural network to infer a feature of the input data, the inference processing method comprising:
storing, in a first memory, the input data;
storing, in a second memory, the weight;
storing, in a third memory, a first value relating to an inference result of the neural network; and
controlling, by a first switching controller, switching between a first operation mode in which calculation of the neural network is performed based on the input data, the weight, and the first value relating at each of the consecutive time steps and a second operation mode in which calculation of the neural network is performed based on the input data and the weight at each of the consecutive time steps, wherein the first value is an inference result obtained through calculation of the neural network at an immediately previous time step of the consecutive time steps.

17. The inference processing method according to claim i6, further comprising:
determining whether or not the first operation mode or the second operation mode has ended based on a preset condition regarding a number of pieces of input data to be processed; and
generating a control signal indicating switching between the first operation mode and the second operation mode based on whether or not the first operation mode or the second operation mode has ended.

18. The inference processing method according to claim 17, further comprising:
reading the input data corresponding to a preset batch size from the first memory when the control signal indicates switching to the second operation mode,
perform batch-process calculations of the neural network based on the input data corresponding to the preset batch size and the weight in the second operation mode to infer a feature of the input data.

19. The inference processing method according to claim i6, further comprising:
storing, in a fourth memory, a second value relating to an internal state of an intermediate layer of the neural network; and
controlling switching between a third operation mode in which calculation of the neural network is performed using the second value at each of the consecutive time steps and a fourth operation mode in which calculation of the neural network is performed is performed without using the second value at each of the consecutive time steps, wherein the second value is an internal state of the intermediate layer of the neural network at an immediately previous time step of the consecutive time steps.

20. The inference processing method according to claim 19, further comprising:
determining whether or not the third operation mode or the fourth operation mode has ended based on a preset condition regarding a number of pieces of input data to be processed; and
generating a control signal indicating switching between the third operation mode and the fourth operation mode based on whether or not the third operation mode or the fourth operation mode has ended.

21. The inference processing method to claim 16, wherein the neural network is a recurrent neural network.
